(19) United States
(12) Patent Application Publication
(10) Pub. No.: US 2026/0332571 A1
(43) Pub. Date: Oct. 22, 2026

(54) DEFENDERS ON ZERO-TRUST ACCESS

(71) Applicant: Capital One Services, LLC, McLean, VA (US)

(72) Inventors: Sarvani Kare, Clarksville, MD (US); Leowell Ardley Bacudio, Raleigh, NC (US); Rachel Diamond, Waltersburg, PA (US); Narender Beniwal, Orpington (GB); Gineesh George, Reading (GB)

(21) Appl. No.: 19/184,662

(22) Filed: Apr. 21, 2025

(51) Int. Cl. H04L 9/40; H04L 41/16

(52) U.S. Cl. CPC H04L 63/08; H04L 41/16; H04L 63/102; H04L 63/105; H04L 63/1425

(57) ABSTRACT

Systems described herein may secure zero-trust access in a computing network. A trust decision server may aggregate employee data, including identity data, permission data, and corresponding risk scores, from multiple datasets and uses this information to train a machine learning model, such as an artificial neural network. When a user device associated with a first employee sends an authentication request associated with a first account, the trust decision server may retrieve that employee's identity and permission data and provide it to the trained machine learning model. The model may output a risk score based on the first employee data. Accordingly, the trust decision server may grant, based on the first risk score not exceeding a predetermined threshold, the request for authentication by providing the user device access to a network resource using the first account.

Aspects of the disclosure relate generally to big data and more specifically to the processing user authentication requests to access network resources.

### BACKGROUND

An organization may process user requests for network resource access and enforce polices for workforce identity authentication process. Conventional systems that rely on role-based access control (RBAC) often grant users more privileges than necessary for their assigned tasks, thereby increasing the risk of data breaches. Moreover, these systems typically offer limited threat detection capabilities because they do not consider contextual information. As a result, these conventional systems may be ineffective in identifying insider threats or detecting unusual network activities.

Aspects described herein may address these and other problems, and generally improve the accuracy, efficiency, and speed of computer-implemented authentication with more comprehensive and adaptive approaches to defend zero-trust access in a secured network in real time.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems as described herein may include features for processing user data for authentication requests and defending zero-trust access. Zero-trust access may be established based on the principle that no user, device, or application—whether inside or outside an enterprise network—should be trusted by default. A trust decision server may receive, from a plurality of datasets, employee data indicating, for each of a plurality of employees of an organization: employee identity data, employee permission data and/or a corresponding employee risk score. The trust decision server may generate a trained machine learning model configured to output employee risk values by training, based on the employee data, an artificial neural network. The artificial neural network may include a plurality of neurons. In some examples, each neuron may comprise a register, a microprocessor, and at least one input, and a plurality of synaptic connections, each synaptic circuit including a memory for storing a synaptic weight, and each neuron connecting to at least one other neuron via one of the plurality of synaptic connections. Training the artificial neural network may include modifying one or more synaptic weights of the plurality of synaptic connections based on the employee data. The trust decision server may receive, from a user device associated with a first employee, a request for authentication associated with a first account and receive, from the plurality of datasets, first employee identity data corresponding to the first employee, and first employee permission data corresponding to the first employee. The trust decision server may provide, to one or more input nodes of the trained machine learning model, the first employee identity data and the first employee permission data, and receive, as output from one or more output nodes of the trained machine learning model, a first risk score associated with the first account. Accordingly, the trust decision server may grant, based on the first risk score not exceeding a predetermined threshold, the request for authentication by providing the user device access to a network resource. These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example of deep neural network architecture for a model according to one or more aspects of the disclosure;

FIG. 3 shows an example of a system for processing authentication requests and defending zero-trust access in which one or more aspects described herein may be implemented;

FIG. 4 shows a flow chart of a process for processing authentication requests and defending zero-trust access according to one or more aspects of the disclosure; and

FIG. 5 shows example candidate features for a trust decision model according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects described herein may relate to processing employee data for user authentication requests and defending zero-trust access. Zero-trust access may be a security framework based on the principle that no user, device, or application—whether inside or outside a network—should be trusted by default. Instead, every access request may need to be continuously verified through authentication, authorization, and encryption measures before granting any access to resources in the organization. This model may enforce the principle of least privilege and often employ micro-segmentation and dynamic context-based policies to minimize potential attack surfaces and prevent lateral movement within a network. The zero-trust access may resolve the technical challenges of potential data breaches caused by over-privileged user in a role-based access control scheme and enhance network security in an enterprise network. A trust decision server may receive, from a plurality of datasets, employee data including employee identity data, employee permission data, and/or a corresponding employee risk score. The trust decision server may generate a trained machine learning model configured to output employee risk values. The trained machine learning model may include an artificial neural network. The artificial neural network may include a plurality of neurons. In some examples, each neuron may include a register, a microprocessor, at least one input, and a plurality of synaptic connections. Each synaptic circuit may include a memory for storing a synaptic weight, and each neuron may be connected to at least one other neuron via one of the plurality of synaptic connections. Training the artificial neural network may include modifying one or more weights of the plurality of synaptic connections based on the employee data. The trust decision server may receive, from a user device of a first employee, a request for authentication associated with a first account and may receive, from the plurality of datasets, first employee identity data and first employee permission data corresponding to the first employee. The trust decision server may provide, to one or more input nodes of the trained machine learning model, the first employee identity data and the first employee permission data. The trust decision server may receive, as output from one or more output nodes of the trained machine learning model, a first risk score associated with the first account. The trust decision server may output, based on the first risk score, an indication of whether the request for authentication is granted. One advantage of this output is that it may serve to defend zero-trust access by improving the security of an authentication process. For example, the trust server may grant, based on the first risk score not exceeding a predetermined threshold, the request for authentication by providing the user device access to a network resource using the first account.

The request for authentication may comprise authentication credentials, and the trust decision server may still grant the user device to access the network resource, based on the first risk score and after determining that at least a portion of the authentication credentials are incorrect. For example, the trust server may grant the request for authentication by providing the user device access to a network resource using the first account, based on the first risk score not exceeding a predetermined threshold. The trust decision server may identify, after granting the request for authentication, one or more malicious actions taken by the first employee or first account, and determine a new risk score for the first account. The trust decision server may further train the trained machine learning model based on the first employee identity data, the first employee permission data and the new risk score.

The trust decision server may receive the employee data by causing output, in a user interface, of the employee identity data and the employee permission data, and receiving, from a user and via the user interface, the corresponding employee risk score. The employee identity data may include one or more of a job identifier, an employee identifier, or an employee termination date. The trust decision server may determine, based on a predicted response time of the trained machine learning model, a number of features to collect in the employee data. In some examples, the first employee permission data may include an indication of a number of members of a community that the first employee belongs to. The trust decision server may convert the employee data from the plurality of datasets into a standard format, and may merge, based on the standard format, the employee identity data, the employee permission data and the corresponding employee risk scores to a unified dataset.

The identity trust server may identify an entity identifier (EID) as a primary key in each of the plurality of the datasets, and generate a processed dataset by joining, based on the EID, the plurality of datasets. The trust decision server may analyze the processed dataset to identify potential biases based on a historical pattern of the processed dataset, and further train the trained machine learning model by adjusting the one or more synaptic weights of the plurality of synaptic connections to mitigate the potential biases. The trust decision server may determine correlations between one or more features in the employee data, and may determine, for a group of features in the employee data, a correlation exceeding a threshold value. The trust decision server may select a specific feature from the group of features as a representative feature for the group to mitigate overfitting. The trust decision server may select, based on the correlation, a plurality of features to train the machine learning model. The trust decision server may use a random forest algorithm to determine the employee risk values based on the employee data, and a plurality of decision trees may be trained based on different subset of the employee data. The trust decision server may categorize, based on historical patterns, the employee data into a plurality of clusters; and determine, a particular employee that is far from a cluster center as a potential anomaly.

Aspects described herein improve the functioning of computers by improving the accuracy, efficiency, and speed of computer-implemented authentication. Computer authentication processes are generally expected to be speedy, accurate, and easy for a legitimate user to complete while simultaneously difficult for a malicious user to successfully complete. The steps described herein recite improvements to computer-implemented authentication, and in particular improve the accuracy and utility of employee data that may be collected to defend zero-trust access in a computing network. Many of the steps described herein, such as use of a machine learning model (e.g., a trust decision model), improve the speed and accuracy of a process by allowing computing devices to consider more/different data than they might ordinarily be able to consider in the context of authentication. Instead of relying on the logics of multitude of “if” statements to evaluate whether a user request meets a fixed number of conditions, the trust decision system may leverage the machine learning model to process employee data dynamically and make decisions in real time. In turn, aspects described herein remedy problems specific to computer-implemented processes, and the processes described herein could not be performed in the human mind (and/or, e.g., with pen and paper). For example, as will be described in further detail below, the processes described herein use complex machine learning techniques and rely on interaction between the user device and a trust decision server, the collecting and processing of dynamically generated employee data, and the use of various machine learning models.

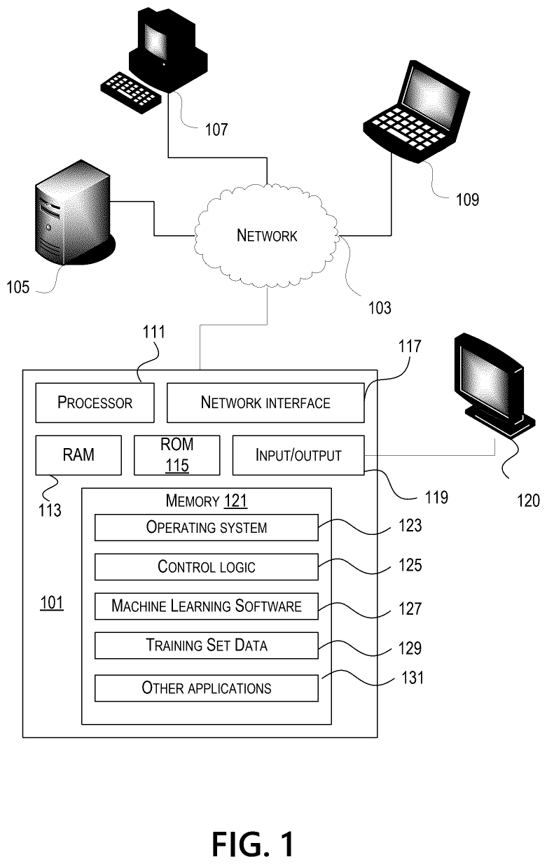

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

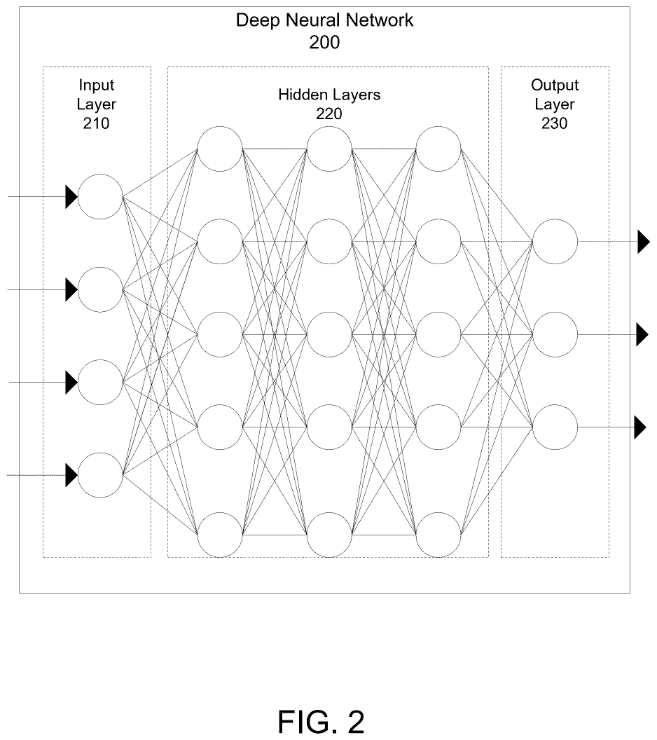

FIG. 2 illustrates an example deep neural network architecture 200. Such a deep neural network architecture might be all or portions of the machine learning software 127 shown in FIG. 1. That said, the architecture depicted in FIG. 2 need not be performed on a single computing device, and might be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Each node in the artificial neural network may correspond to neuron. The artificial neural network may include a plurality of neurons organized in an array, where each neuron may include a register, a microprocessor and at least one input, and a plurality of synaptic connections. Each synaptic circuit may include a memory for storing a synaptic weight, and each neuron is connected to at least one other neuron via one of the plurality of synaptic connections. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model. Training the artificial neural network may include modifying one or more synaptic weights of the plurality of synaptic connections based on the employee data.

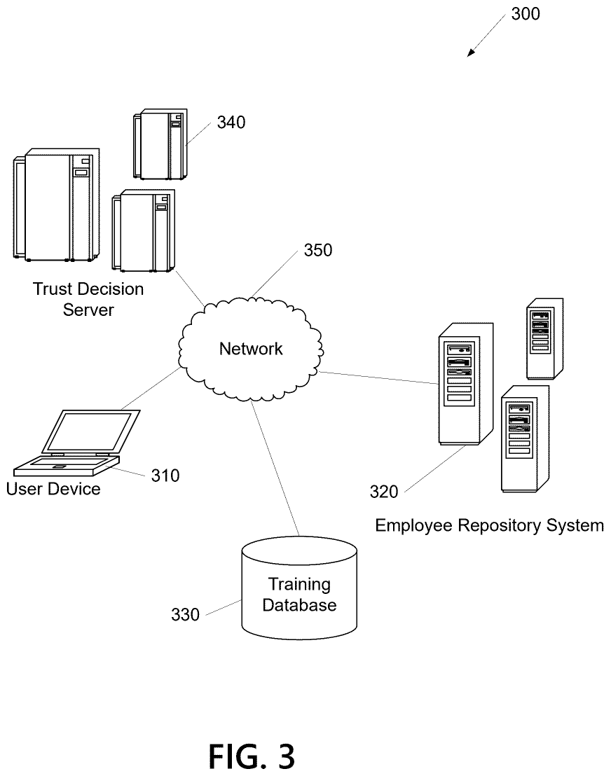

FIG. 3 depicts a system 300 for processing authentication requests and defending zero-trust access. The trust decision system 300 may include at least one user device 310, at least one employee repository system 320, at least one training database 330, and/or at least one trust decision server 340 in communication via a network 350. The network connections shown are illustrative, and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 1.

User device 310 may execute an application and use the application to interact with employee repository system 320 and/or trust decision server 340. User device 310 may send a request for authentication associated with a first account. For example, the authentication may be related to a request to access a resource or an asset in an enterprise network. A user may provide the credentials via a user interface of the application executed on user device 310. User device 310 may receive an indication of whether the request for authentication is granted based on a first risk score associated with the first account. The first risk score may be generated using a machine learning model. For example, after the user enters the credential for authentication, if at least a portion of the authentication credentials is incorrect, user device 310 may receive an indication that the request for authentication is denied. Alternatively, if at least a portion of the authentication credentials is incorrect and the first risk score does not exceed a threshold value, user device 310 may still receive an indication that the request for authentication is granted. In another example, after the user enters the credential for authentication, if the first risk score exceeds a threshold value, user device 310 may receive an indication that the request for authentication is denied, regardless whether the authentication credentials are correct. Alternatively, if the authentication credentials are correct and the first risk score does not exceed a threshold value, user device 310 may receive an indication that the request for authentication is granted.

User device 310 may use the application to receive and send employee information related to employee data, employee risk scores and indications whether the authentication requests have been granted or denied. The employee information may be exchanged among user device 310, employee repository system 320 and trust decision server 340. User device 310 may also use other mechanisms (e.g., Application Programming Interfaces (APIs), cookies, front end or server end code, integrations with Content Management System (CMS), applications on ecommerce platforms, etc.) to receive and send the employee data. The employee information or data may include, for example, employee identity data, employee permission data, and employee asset data. The employee information may include user devices information related to the user devices 310 that the employees use to log in and interact with an enterprise network. For example, the user device information may include timestamps and locations of user device logins, the files and cloud storage usage requested by the user devices, the database queries run by the user devices, a number of user devices used by a particular employee to log in to the network, a frequency of access by the user devices for that employee, and the like. The User device 310 may display an employee risk score corresponding to the employee data in the user interface. User device 310 may present the employee data in the user interface and ask the user to enter a feedback. The user may enter a corresponding employee risk score to train a machine learning model to make better predictions on employee risk score values.

Employee repository system 320 may collect, parse, and/or store employee information including employee identity data and employ permission data. The employee data may be collected from a plurality of datasets and various sources in the organization. The employee information may include text, pictures, graphics, audio and video files, etc. Employee repository system 320 and trust decision server 340 may form a decision engine that executes an application or web interface on user device 310 to receive and process authentication requests.

Training database 330 may receive, store and provide training data to train different machine learning models. Training database 330 may store training data to train a machine learning model to determine employee risk values. The training data may include historical employee data comprising historical employee identity data, historical employee permission data and historical employee asset data. The training data may include pre-determined or pre-labeled risk scores related to the employees, the permissions and the assets in the historical employee data. In some examples, employee repository 320 and training database 330 may be merged into one data repository.

Trust decision server 340 may receive the employee data including the employee identity data, employee permission data and a corresponding employee risk score from a plurality of datasets. The employee data from various datasets may be in a non-standard format, such as a non-structured form, or in the form of a line of data in a log file, or a text format, or a .csv file. Trust decision server 340 may convert the employee data from the plurality of datasets into a standard format such as a JSON or XML format. Trust decision server 340 may merge, based on the standard format, the employee identity data, the employee permission data and the corresponding employee risk scores to a unified dataset.

Trust decision server 340 may generate a trained machine learning model configured to output employee risk values. The machine learning model may be an artificial neural network including a plurality of neurons. In the training process, trust decision server 340 may modify one or more weights of the plurality of synaptic connections of the neurons based on the employee data.

Trust decision server 340 may receive, from user device 310, a request for authentication associated with a first account. Trust decision server 340 may receive, from the plurality of datasets, first employee identity data corresponding to the first employee, and first employee permission data corresponding to the first employee. Trust decision server 340 may provide, to one or more input nodes of the trained machine learning model, the first employee identity data and the first employee permission data. Trust decision server 340 may receive, as output from one or more output nodes of the trained machine learning model, a first risk score. Based on the first risk score, trust decision server 340 may output an indication of whether the request for authentication is granted to user device 310.

User device 310, employee repository system 320, training database 330, and/or trust decision server 340, may be associated with a particular authentication session. Trust decision server 340 may receive prompts, process employee information, and/or share various risk scores and indications of whether the request for authentication is granted or denied with user device 310, employee repository system 320, and/or training database 330, as described herein. However, it should be noted that any device in the trust decision system 300 may perform any of the processes and/or store any data as described herein. Some or all of the data described herein may be stored using one or more databases. Databases may include, but are not limited to, relational databases, hierarchical databases, distributed databases, in-memory databases, flat file databases, XML databases, NoSQL databases, graph databases, and/or a combination thereof. The network 360 may include a local area network (LAN), a wide area network (WAN), a wireless telecommunications network, and/or any other communication network or combination thereof.

The data transferred to and from various computing devices in trust decision system 300 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the trust decision system 300. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in the trust decision system 300 in front of one or more computing devices such that any external devices may communicate directly with the specialized hardware.

The trust decision system may insert an enhanced security layer between a policy enforcement and decision-making points in an enterprise network system. The trust decision system may collect and process employee information to make more robust decisions about whether to grant or deny user authentication requests regarding access to enterprise network resources. Instead of relying on the logics of multitude of “if” statements to evaluate whether a user request meets a fixed number of conditions, the trust decision system may leverage a machine learning model (e.g., a trust decision model) to process employee data dynamically and make decisions in real time. The trust decision system may aggregate employee data from various datasets by joining on a common entity ID (EID) and transform the data for bias detection and feature extraction. The machine learning model—such as one that might implement a random forest classifier—may efficiently handle large, high-dimensional datasets with high accuracy while preventing overfitting, and it delivers response times in milliseconds, thereby minimizing disruption to the authentication process.

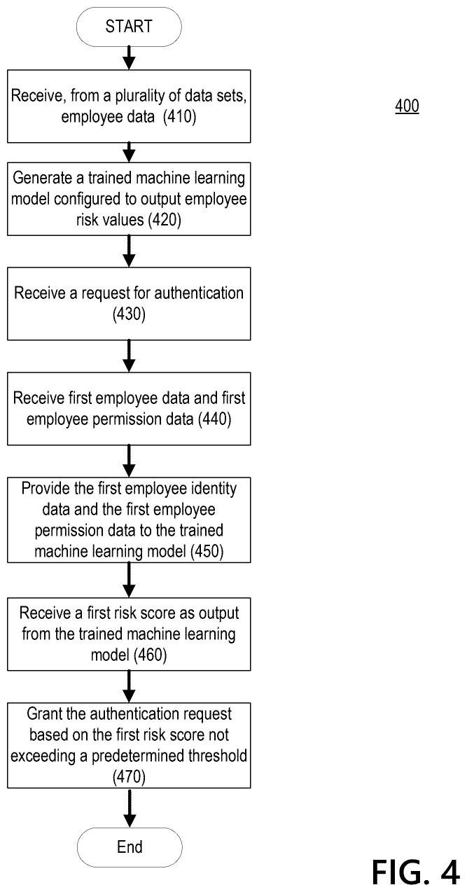

FIG. 4 shows a flow chart of a process for processing authentication requests defending zero-trust access according to one or more aspects of the disclosure. Some or all of the steps of process 400 may be performed using one or more computing devices as described herein.

At step 410, a trust decision server (e.g., trust decision server 340) may receive employee data from a plurality of datasets. The employee data may be retrieved from employee repository system 320 or training database 330, which may store historical employee data. The employee data including device information may be received from a user device. For example, user device 310 may send an IP address or a location of user device 310 that is associated with a first employee in real time. The employee data may be used as basis for candidate feature selection for the trust decision model to predict risk scores.

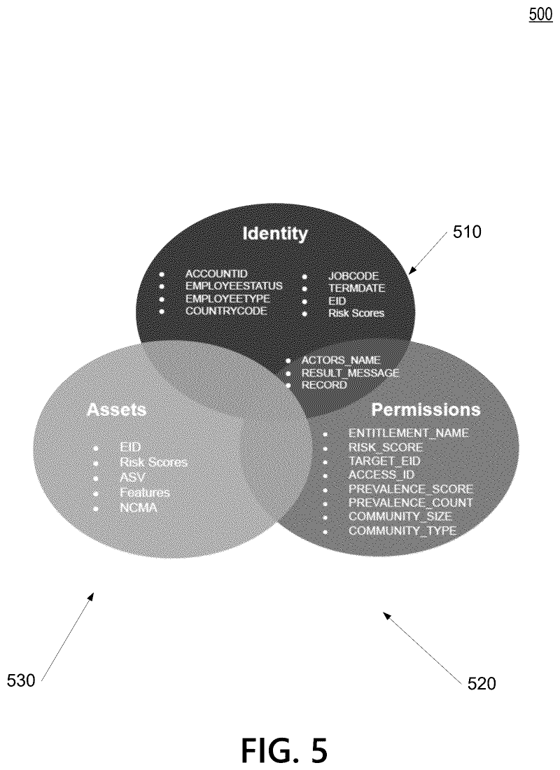

FIG. 5 shows example candidate features for a trust decision model according to one or more aspects of the disclosure. The candidate features may be generated based on employee data received by the trust decision server. As illustrated in FIG. 5, the employee data may include employee identity data 510, employee permission data 520 and employee asset data 530.

Employee identity data 510 may include an employee account identifier, which is a unique identifier for an employee's system account within the organization. The account identifier may be a number or code linking the employee to his or her digital profile and associated access rights. Employee identity data 510 may include employee status indicating the current status of the employees, for example, whether they are active, on leave, or terminated. The employee status may help determine who should have access to enterprise resources at any given time. Employee identity data 510 may include an employee type that categorizes the employee by their role or nature of employment (e.g., full-time, part-time, contractor, temporary). Different types might have different access privileges or monitoring requirements. Employee identity data 510 may include a country code, which is a standardized code representing the country where the employee is located. The country code may be useful for applying region-specific policies, regulations, and security measures. Employee identity data 510 may include a job code or title that is assigned to an employee's job role or function. The job code may help to determine access needs and risk profiles. Employee identity data 510 may include a termination date, which is the date on which an employee's service ended. This field may help to de-provision access once the employee leaves the organization. Employee identity data 510 may include an Employee ID (EID), which is a unique identifier assigned to the employee that remains constant across various systems in the organization. EID may help to ensure consistency when tracking employee-related data and activities in the organization. Employee identity data 510 may include an employee risk score, which is quantitative metrics assigned to an employee based on other factors in the employee identity data indicating overall exposure to potential insider threats. These data points in employee identity data 510 may create a detailed profile for each employee, allowing the organization to ensure compliance with policies and proactively mitigate risks.

Employee permission data 520 may include an entitlement name, a target asset identifier, an access identifier, a prevalence score, a prevalence count, a prevalence count, a community size, a community type, risk score associated with the access, and the like. An entitlement name may be a description of a specific permission or access right and may define what the permission allows a user to do, for example, viewing financial reports or holding an administer user account. The permission risk score may be a quantitative metric indicating the potential risk associated with a given permission. These scores may consider factors like the sensitivity of data accessible under the entitlement and the likelihood of misuse. The target entity ID may be a unique identifier for an employee or an asset that is granted the permission. The target EID links the entitlement to the specific employee, asset or system within the organization. The access ID may be a unique identifier assigned to a particular instance of an access right or permission. The access ID may be used to track, audit, and manage the specific access granted within the organization's systems. The prevalence score may be a ratio or percentage that reflects how common a specific permission is among the total user population in the organization. It may be calculated by dividing the number of users with the entitlement by the total number of users. The prevalence count may be the absolute number of users who have been granted the particular permission. While the prevalence score may provide a relative idea, the prevalence count indicates the exact number of cases. The community size may be a number of users in a defined group or community that share similar roles or permissions. The community size helps in understanding the scale of impact if a particular permission needs to be modified or revoked. The community type may be a categorization of the group based on factors such as job function, department, or risk level. This classification helps determine what security controls, policies, or reviews are appropriate for that specific group. These metrics in employee permission data 520 may provide a comprehensive framework for evaluating how permissions are distributed across the organization, assessing potential risks, and guiding effective access management strategies. Employee identity data 510 and employee permission data 520 may share overlapping values such as an actor (e.g., employee) name, a record corresponding to the actor name, and a result message indicating such overlapping values.

Employee asset data 530 may include an asset EID, which is a unique identifier assigned to each asset or resource. The EID may help to ensure that every asset is uniquely tracked and referenced within the organization's inventory and risk management systems. Employee asset data 530 may include a risk score, which is a quantitative or qualitative metric that represents the potential risk associated with an asset. The asset risk score may be determined based on factors such as the likelihood of a threat exploiting a vulnerability, the potential impact on the organization, and the asset's overall importance. Employee asset data 530 may include an Asset Security Value (ASV) that reflects the inherent value or criticality of an asset from a security standpoint. ASV may help prioritize assets by assigning a value based on factors like data sensitivity, operational importance, or financial impact, guiding how much protection or security investment is warranted for a particular asset. Employee asset data 530 may include asset features, referring to the specific attributes or characteristics of an asset that are relevant to its risk profile. These features might include details about configuration, connectivity, usage or any other properties that could affect the asset's vulnerability to threats. Employee asset data 530 may include Normalized Control Maturity Assessment (NCMA), which is a metric used to assess the maturity and effectiveness of the security controls implemented to protect an asset. By normalizing this assessment on a standardized scale, organizations may evaluate how well different assets are secured relative to industry standards or internal benchmarks, and identify areas for improvement. These metrics in employee asset data 530 may provide a comprehensive view of an asset's risk landscape and help an organization allocate resources and implement controls where they are needed most.

The employee data from various datasets may be in a non-standard format, such as a non-structured form, or in the form of a line of data in a log file, or a text format. The trust decision server may convert the employee data from the plurality of datasets into a standard format such as a JSON or XML format. The trust decision server may merge, based on the standard format, the employee identity data, the employee permission data, the employee asset data and the corresponding risk scores to a unified dataset.

Referring back to FIG. 4, at step 420, the trust decision server may generate a trained machine learning model. For example, trust decision server 340 may generate a trained machine learning model configured to output employee risk values. The machine learning model may be an artificial neural network including a plurality of neurons organized in an array, and each neuron may include a register, a microprocessor, at least one input and a plurality of synaptic connections. Each synaptic circuit may include a memory for storing a synaptic weight, and each neuron is connected to at least one other neuron via one of the plurality of synaptic connections. In the training process, the trust decision server may modify one or more synaptic weights of the plurality of synaptic connections based on the employee data.

The trust decision server may train the machine learning model to determine risk score values based on historical employee information. The historical employee information may include historical employee identity data, historical employee permission data and/or historical asset data related to different employees in the organization. The employees may have different statuses, types, job roles and from different countries or geographic areas. The employees may be associated with pre-labeled employee identity risk scores. The employees may have different entitlements for different assets, different prevalence scores and counts, and the employees may from different communities of various sizes. The employees may be associated with pre-labeled employee permission scores. The employees may be related to different assets having varying features, ASV or NCMA values. The employees may be associated with pre-labeled employee asset risk scores. The employees may be also associated with pre-labeled aggregated risk scores, which may be based on one or more of the employee identity risk scores, the employee permission scores or the employee asset scores.

The training data may be stored in the unstructured format such as in .csv files. The training data may be stored in structured format or in databases such as training databases 330. The machine learning model may be a supervised machine learning model. The supervised machine learning model may be trained based on user feedback verifying the risk scores of the employee data in a QA environment. The machine learning model may be re-trained based on the user feedback. One or more users may indicate that whether a risk score is appropriate for the employee data, or enter an appropriate risk score, and the machine learning may be trained based on the user feedback to recalculate the risk scores. For example, a user may be presented with employee data including two records: the first record indicating a high spike in logins at 2 AM from an unknow IPs originated from a foreign country; the second record indicating a moderate increase in logins at 7 PM from the VPN IP range. The user may enter a relatively higher risk score for the first record and a relatively lower risk score for the second record. One or more users providing the feedback may be different from the first employee sending a request for authentication. The trust decision server may determine, based on a predicted response time of the machine learning model, a number of features to collect in the employee data to continuously refine feature selection and re-train the machine learning model to adapt to changing patterns in the employee data. The trust decision server may reduce the number of features that lead to a simpler model with faster response time while maintaining or improving the accuracy of prediction.

During the model training process, the weights of each connection and/or node may be adjusted as the model adapts to generate more accurate predictions on a training set. The weights assigned to each connection and/or node may be referred to as the model parameters. For example, the trust decision server may use a deep learning model and the model may be initialized with a first set of model parameters. The machine learning model may use the training data as input based on the first set of model parameter and determine a risk score for a candidate response with a first confidence level. The trust decision server may generate a second set of model parameters based on the adjustment on the first set of model parameters. The machine learning model may use the training data as input based on the second set of model parameter and determine a second risk score with a second confidence level. Based on a comparison between the first confidence level and the second confidence level, the trust decision server may determine a more optimal set of parameters between the first set of model parameters and the second set of model parameters. The trust decision server may go through several iterations, and the second machine learning model may be tuned with a set of optimal model parameters when the confidence level reaches a predetermined threshold (e.g., 95%).

The trust decision server may identify an EID as a primary key in each of the plurality of the datasets and generate a processed dataset by joining, based on the EID, the plurality of datasets. For example, the historical employee identity data and the historical permission data may each include an EID representing a unique employee identifier. The historical employee identity data and the historical permission data may be joined based on the common EID to generate a processed dataset merging the employee identity and permission data. In another example, the historical employee identity data and the historical permission data may each include an EID representing a unique asset identifier. The historical employee identity data and the historical permission data may be joined based on the common EID to generate a processed dataset merging the employee permission and asset data. In still another example, the historical employee identity data and the historical permission data may be joined based on the common EID to generate a first processed dataset merging the employee identity and permission data. The first processed dataset may be further joined with the historical employee asset data based on the common entity ID for the asset to generate a second processed dataset to train the machine learning model. The processed datasets may provide a comprehensive view of each employee, and his/her permissions on assets across the organization.

In some example, the machine learning model may include a random forest algorithm. The random forest mechanism may be a supervised learning algorithm that builds an ensemble of decision trees to improve predictive accuracy and reduce overfitting. The random Forest mechanism may combine the outputs of multiple, different decision trees to arrive at a final prediction. The trust decision server may analyze the processed dataset to identify potential biases based on a historical pattern of the processed dataset. The trust decision server may further train the trained machine learning model by adjusting the one or more synaptic weights of the plurality of synaptic connections to mitigate the potential biases. The trust decision server may determine correlations between one or more features in the employee data. The trust decision server may determine, for a group of features in the employee data, the correlation exceeding a threshold value. The trust decision server may select a specific feature from the group of features as a representative feature for the group to mitigate overfitting. Removing irrelevant or highly correlated features beforehand may improve performance of the machine learning model. The trust decision server may select, based on the correlation, a plurality of features to train the machine learning model. The trust decision server may determine, based on a predicted response time of the machine learning model, a number of features to collect in the employee data to as training data to refine the machine learning model.

Random forest mechanism may use bootstrap aggregation (e.g., bagging) technique, where it randomly samples subsets of the training data with replacement. Each decision tree may be trained based on a different subset of the employee data, and this approach may introduce variability and reduce overfitting. Training the machine learning model may include generating a first decision tree of the machine learning model using a first subset of the dataset. For example, using a first subset of the dataset may include selecting a first subset of employee data that includes historical employee identity data, historical permission data, and/or historical asset data that corresponds to a first subset of employees.

Training the machine learning model may include generating a second decision tree of the machine learning model using a second subset of the dataset. For example, using a second subset of the dataset may include selecting a second subset of employee data that includes historical employee identity data, historical permission data, and/or historical asset data that corresponds to a second subset of employees. The second subset of the dataset may be different from the first subset of the dataset (e.g., the second subset may include employee data that was not included in the first subset of the dataset). The second subset of the dataset may include some information that is in the first subset of the dataset (e.g., the second subset may include some information that is in the first subset and may also include some information that is not in the first subset). After all decision trees are trained, the trust decision server may make a final prediction based on a voting mechanism, where each tree votes for a classification (e.g., fraudulent or non-fraudulent), and the most common classification may be chosen as the final prediction. The trust decision server may make a final prediction based on regression, by averaging the risk scores generated from all or a majority of the decision trees as a final risk score.

The trust decision server may use hyperparameter tuning to optimize a set of hyperparameters and improve the performance of the machine learning model. For example, based at least in part on use of a loss function associated with the accuracy of predicting the risk scores, the trust decision server may adjust one or more hyperparameters that may be associated with minimization of the loss (e.g., the hyperparameters that result in a lower loss that corresponds to more accurate prediction of risk scores). The one or more hyperparameters may include a number of decision trees that are used, a number of nodes in a decision tree which may be associated with the depth of a decision tree, a size of a one or more subsets of data, and/or a learning rate. For example, hyperparameter tuning may be used to determine the number of decision trees that are used based in part on the extent to which the addition of another decision tree results in greater accuracy of predicting the risk scores. The system may determine a number of decision trees beyond which the addition of another decision tree does not increase (or decreases) the accuracy of predicting the risk scores. Improving an accuracy of predicting the risk scores may include increasing a true positive rate (e.g., predicting a relatively low risk score when the request is from a fraudulent user) and/or decreasing a false positive rate (e.g., predicting a relatively high risk score when the request is from a legitimate user).

Configuring and/or training the machine learning model may include the use of out of sample testing to monitor the efficacy of the machine learning model. For example, the machine learning model may be tested using one or more datasets that are different from the dataset that was used to configure and/or train the machine learning model. The out of sample testing may include out of time testing that does not include the dataset that was initially used to configure and/or train the machine learning model. For example, out of time testing of the machine learning model may include the use of a set of employee data that does not overlap with the set of employee data in the initial dataset used to configure and/or train the machine learning model. Based on the results of the out of time testing, the machine learning model may be periodically trained and/or calibrated using more up to date datasets. In some examples, configuring and/or training the machine learning model may include the use of in time testing in which a portion (e.g., eighty percent (80%)) of the dataset is used to test twenty percent of the dataset. For example, a first employee dataset associated with eighty percent (80%) of the employees may be tested on a second employee dataset associated with twenty percent (20%) of the employees. The twenty percent (20%) of the employee included in the second employee dataset may overlap with the first employee dataset, but will be different due to the different size of the dataset.

The trust decision server may use a K-means clustering algorithm to determine the employee risk values. The K-means clustering algorithm may be an unsupervised machine learning algorithm used to partition a dataset into a specified number of clusters. The trust decision server may categorize the employee data into a plurality of clusters based on historical patterns. The historical patterns may include the employees' typical working hours. For example, the employees usually log in to their working devices between 8 AM to 7 PM. If a device logs in at odd hours (e.g., 2 AM) might indicate suspicious activity. The historical patterns may include a frequency of logins. If the employees generally log in once or twice per day, and a sudden spike in logins could indicate an account compromise. The historical patterns may include login location. If the employees typically log in from a corporate office or VPN IP range, a login from a foreign country or unknown IP could be flagged. The historical patterns may include file access patterns. The employees may typically access a specific set of files based on their roles. Downloading unusual or large files may be related to suspicious activities. The historical patterns may include database queries. For example, human resource employees typically access payroll databases, while engineers typically access code repositories. Accessing restricted areas may be connected to elevated risk scores. The historical patterns may include cloud storage usage. For example, normal data transfer is below 10 MB per session. Transferring gigabytes of data may indicate data exfiltration and data theft. The trust decision server may determine that a particular employee that is far from a cluster center as a potential anomaly or a fraudulent user whose request may be denied.

At step 430, the trust decision server may receive a request for authentication associated with a first account. The request may be associated with access, by a first employee, to a website, an application, or the like. For example, the trust decision server may receive an indication of a request, from a user device of the first employee, for access to an account responsive to a user accessing a log-in page, or the like. The request may specifically identify an account via, for example, an account number, a username, or the like. The first employee may further provide the login credentials associated with accessing the account or the resource.

At step 440, the trust decision server may receive first employee identity data and permission data. Optionally, the trust decision server may also receive first employee asset data. If needed, the trust decision server may convert the first employee identity data, the first employee permission data and the first employee asset data to a standard format. The decision server may identify an EID as a primary key in each of the plurality of the datasets and generate a processed dataset by joining, based on the EID, the plurality of datasets.

At step 450, the trust decision server may input the first employee identity data and the first employee permission data to the trained machine learning model. For example, the trust decision server may input the processed dataset related to the first employee to the machine learning model.

At step 460, the trust decision server may receive, as output from the trained machine learning model, a first risk score associated with the first account. After the machine learning has been trained based on pre-labeled employee data from different users, the trained first machine learning model may be used to generate a risk score for the authentication request from the first account.

At step 470, the trust decision server may grant the request for authentication by providing the user device access to a network resource based on the first risk score not exceeding a predetermined threshold. The trust decision server may compare the first risk score with the predetermined threshold value. If the first risk score falls below or is equal to the threshold value, the trust decision server may grant the request for authentication by providing the user device access to a network resource using the first account. If the first risk score exceeds the threshold value, the trust decision server may deny the request for authentication using the first account. In some examples, even that at least a portion of the authentication credentials provided by the user device are incorrect, the trust sever may still grant the authentication request based on the risk score not exceeding the threshold value.

The trust decision server may monitor the activity of the first account after issuing an authentication decision. For example, the trust decision server may detect malicious activities by the first account, such as repeated failed login attempts, unauthorized access to sensitive resources, abnormal file downloads, or data transfers outside of normal working hours. The malicious actions may have occurred on a different server or network from the current network resource that the first account attempts to access. The malicious actions may be related to one or more other user devices associated with the first employee. The trust decision server may compute an updated risk score for the first account. The trust decision server may then retrain the machine learning model using the first employee's identity data, permission data, and the new risk score to refine future access decisions.

The trust decision server may cause output, in a user interface, of the employee identity data and the employee permission data. The user may provide feedback on the display data and input a corresponding risk score that the user sees fit. For example, an administrator of the network may have visibility to various user access in the network and may set risk scores corresponding to the risk level according to the access to train or re-train the machine learning model. The trust decision server may receive, from a user and via the user interface, the corresponding employee risk score. The trust decision server may use the user feedback to further train the machine learning model to make more accurate predictions.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computing device, comprising:
one or more processors; and
memory storing instructions that, when executed by the one or more processors, cause the computing device to:
receive, from a plurality of datasets, employee data indicating, for each of a plurality of employees of an organization:
employee identity data,
employee permission data, and
a corresponding employee risk score;
generate a trained machine learning model configured to output employee risk values by training, based on the employee data, an artificial neural network comprising:
a plurality of neurons organized in an array, wherein each neuron comprises a register, a microprocessor, and at least one input, and
a plurality of synaptic connections, each synaptic circuit including a memory for storing a synaptic weight, wherein each neuron is connected to at least one other neuron via one of the plurality of synaptic connections,
wherein training the artificial neural network comprises modifying one or more synaptic weights of the plurality of synaptic connections based on the employee data;
receive, from a user device of a first employee, a request for authentication associated with a first account;
receive from the plurality of datasets:
first employee identity data corresponding to the first employee, and
first employee permission data corresponding to the first employee;
provide, to one or more input nodes of the trained machine learning model, the first employee identity data and the first employee permission data;
receive, as output from one or more output nodes of the trained machine learning model, a first risk score; and
grant, based on the first risk score not exceeding a predetermined threshold, the request for authentication by providing the user device access to a network resource.

2. The computing device of claim 1, wherein the request for authentication comprises authentication credentials, and wherein the instructions, when executed by the one or more processors, cause the computing device to grant the request for authentication by causing the computing device to:
output, based on the first risk score and after determining that at least a portion of the authentication credentials are incorrect, an indication that the request for authentication is granted.

3. The computing device of claim 1, wherein the instructions, when executed by the one or more processors, cause the computing device to:
identify, after granting the request for authentication, one or more malicious actions taken by the first account;
determine a new risk score for the first account; and
further train the trained machine learning model based on:
the first employee identity data,
the first employee permission data, and
the new risk score.

4. The computing device of claim 1, wherein the instructions, when executed by the one or more processors, cause the computing device to receive the employee data by causing the computing device to, for each of the plurality of employees of the organization:
cause output, in a user interface, of the employee identity data and the employee permission data; and
receive, from a user and via the user interface, the corresponding employee risk score.

5. The computing device of claim 1, wherein the employee identity data comprises one or more of:
a job identifier,
an employee identifier, or
an employee termination date.

6. The computing device of claim 1, wherein the instructions, when executed by the one or more processors, cause the computing device to receive the employee data by causing the computing device to:
determine, based on a predicted response time of the trained machine learning model, a number of features to collect in the employee data.

7. The computing device of claim 1, wherein the first employee permission data comprises an indication of a number of members of a community that the first employee belongs to.

8. The computing device of claim 1, wherein the instructions, when executed by the one or more processors, cause the computing device to:
convert the employee data from the plurality of datasets into a standard format; and
merge, based on the standard format, the employee identity data, the employee permission data, and the corresponding employee risk scores to a unified dataset.

9. The computing device of claim 1, wherein the instructions, when executed by the one or more processors, cause the computing device to:
identify an entity identifier (EID) as a primary key in each of the plurality of the datasets; and
generate a processed dataset by joining, based on the EID, the plurality of datasets.

10. The computing device of claim 9, wherein the instructions, when executed by the one or more processors, cause the computing device to:
analyze the processed dataset to identify potential biases based on a historical pattern of the processed dataset; and
further train the trained machine learning model by adjusting the one or more synaptic weights of the plurality of synaptic connections to mitigate the potential biases.

11. The computing device of claim 1, wherein the instructions, when executed by the one or more processors, cause the computing device to further train the trained machine learning model by:
determining correlations between one or more features in the employee data;
determining, for a group of features in the employee data, a correlation exceeding a threshold value; and
selecting, based on the correlation, a plurality of features to train the machine learning model.

12. The computing device of claim 1, wherein the instructions, when executed by the one or more processors, cause the computing device to:
use a random forest algorithm to determine the employee risk values based on the employee data, wherein a plurality of decision trees are trained based on different subset of the employee data.

13. The computing device of claim 1, wherein the instructions, when executed by the one or more processors, cause the computing device to use a k-means clustering algorithm to determine the employee risk values by:
categorizing, based on historical patterns, the employee data into a plurality of clusters; and
determining, a particular employee that is far from a cluster center as a potential anomaly.

14. A method comprising:
receive, from a plurality of datasets, employee data indicating, for each of a plurality of employees of an organization:
employee identity data,
employee permission data, and
a corresponding employee risk score;
generate a trained machine learning model configured to output employee risk values by training, based on the employee data, an artificial neural network comprising a plurality of nodes, wherein training the artificial neural network comprises modifying one or more weights of the plurality of nodes based on the employee data;
receive, from a user device of a first employee, a request for authentication associated with a first account;
receive, from the plurality of datasets:
first employee identity data corresponding to the first employee, and
first employee permission data corresponding to the first employee;
provide, to one or more input nodes of the trained machine learning model, the first employee identity data and the first employee permission data;
receive, as output from one or more output nodes of the trained machine learning model, a first risk score; and
grant, based on the first risk score not exceeding a predetermined threshold, the request for authentication by providing the user device access to a network resource using the first account.

15. The method of claim 14, wherein the request for authentication comprises authentication credentials and wherein granting the request for authentication further comprises:
outputting, based on the first risk score and after determining that at least a portion of the authentication credentials are incorrect, an indication that the request for authentication is granted.

16. The method of claim 14, further comprising:
identifying, after granting the request for authentication, one or more malicious actions taken by the first account;
determining a new risk score for the first account; and
further training the trained machine learning model based on:
the first employee identity data,
the first employee permission data, and
the new risk score.

17. The method of claim 14, wherein receiving the employee data comprises:
for each of the plurality of employees of the organization:
causing output, in a user interface, of the employee identity data and the employee permission data; and
receiving, from a user and via the user interface, the corresponding employee risk score.

18. The method of claim 14, further comprising:
using a random forest algorithm to determine the employee risk values based on the employee data, wherein a plurality of decision trees are trained based on different subset of the employee data.

19. One or more non-transitory computer-readable media storing instructions that, when executed by one or more processors, cause a computing device to:
receive, from a plurality of datasets, employee data indicating, for each of a plurality of employees of an organization:
employee identity data,
employee permission data, and
a corresponding employee risk score;
generate a trained machine learning model configured to output employee risk values by training, based on the employee data, an artificial neural network comprising a plurality of nodes implementing a random forest algorithm, wherein training the artificial neural network comprises modifying one or more weights of the plurality of nodes based on the employee data, and wherein a plurality of decision trees are trained based on different subset of the employee data;
receive, from a user device of a first employee, a request for authentication associated with a first account;
receive, from the plurality of datasets:
first employee identity data corresponding to the first employee, and
first employee permission data corresponding to the first employee;
provide, to one or more input nodes of the trained machine learning model, the first employee identity data and the first employee permission data;
receive, as output from one or more output nodes of the trained machine learning model, a first risk score; and
grant, based on the first risk score not exceeding a predetermined threshold, the request for authentication by providing the user device access to a network resource.

20. The one or more non-transitory computer-readable media of claim 19, wherein storing instructions that, when executed by one or more processors, cause the computing device to:
identify, after granting the request for authentication, one or more malicious actions taken by the first account;
determine a new risk score for the first account; and
further training the trained machine learning model based on:
the first employee identity data,
the first employee permission data, and
the new risk score.
